(19) United States
(12) Patent Application Publication
(10) Pub. No.: US 2024/0140106 A1
(43) Pub. Date: May 2, 2024

(54) THETA-Z STEP ALIGNMENT OF ODD AND EVEN COLUMNS OF A PRINTHEAD

(71) Applicant: Hewlett-Packard Development Company, L.P., Spring, TX (US)

(72) Inventors: Victor SERRA FERNANDEZ, Sant Cugat del Valles (ES); Marti RIUS ROSSELL, Sant Cugat del Valles (ES); Leyre HERNANDEZ MARTINEZ, Sant Cugat del Valles (ES)

(73) Assignee: Hewlett-Packard Development Company, L.P., Spring, TX (US)

(21) Appl. No.: 18/051,369

(22) Filed: Oct. 31, 2022

(51) Int. Cl. B41J 2/21; B41J 19/14

(52) U.S. Cl. CPC B41J 2/2135; B41J 19/145

(57) ABSTRACT

Systems, apparatuses, and methods may provide for technology that calibrates a printer alignment. Such calibration includes determining a tilt value for individual columns. A difference is determined between a first set of alignment values of nozzles of a first column of the trench and a second set of alignment values of nozzles of a second column of the trench. A dot offset value is determined based on the difference between the first and second set of alignment values of nozzles of the first and second columns. A top nozzle alignment value of the second column adjusted based on a difference compared against the first set of alignment values of nozzles of the first column and based on the dot offset value.

### BACKGROUND

Technical scan printers are generally used to print CAD plots with many lines of different widths. One features that customers typically request for these types of printers is the capacity to print line plots as quickly as possible, with high image and line quality, as well as with high consistency in the line widths through all the plots. Therefore, single pass print-modes are typically used to satisfy high throughput requests.

When using single pass print-modes, a printing pen of a printhead will typically go through each part of the plot surface only once and the whole printhead is going to be used to paint a line. In these cases, a fundamental problem is that usually the pen is not perfectly vertically aligned with the media. This issue is defined as theta-Z deviation of the printhead.

For printheads that contain two separated trenches (e.g., named odd and even trenches), this theta-Z issue affects both trenches but the tilt for each trench may not be exactly the same. For this reason, as the theta-Z deviation is not always the same for each trench, a one-dot step variation in printing may happen at different sections of the printhead. This typically causes width differences along a single line that is printed by both trenches, specifically in an area of the single line where the one-dot step variation is different for each trench.

### BRIEF DESCRIPTION OF THE DRAWINGS

Various examples will be described below by referencing the following drawings, in which:

FIG. 1 is a schematic view illustrating a printer including a printhead deviated in the z-axis, e.g., being affected by a theta-Z deviation;

FIG. 2 chart illustrating line width variation due to a theta-Z deviation;

FIG. 3 is an illustration of an example printer according to an example;

FIG. 4 is an illustration of an example simplification of a layout of a printer having nozzles on a print head according to an example;

FIG. 5 is a chart illustrating an adjusted trench alignment to address line width variation due to a theta-Z deviation according to an example;

FIG. 6 is an image chart illustrating experimental results of an adjusted trench alignment to address line width variation due to a theta-Z deviation according to an example;

FIG. 7 is an illustration of a flowchart of an example method for column alignment to address line width variation due to a theta-Z deviation according to an example;

FIG. 8 is an illustration of a flowchart of a further example method for column alignment to address line width variation due to a theta-Z deviation according to an example;

FIG. 9 is a block diagram illustrating a computer program product according to an example;

FIG. 10 is a block diagram illustrating an example fluid delivery apparatus according to an example; and

FIG. 11 is a block diagram illustrating a hardware apparatus including a semiconductor package according to an example.

### DETAILED DESCRIPTION

As will be discussed in greater detail below, some implementations described herein ensure that both odd and even one-dot steps happen at the same position of the printhead. This will generate lines that still have one-dot steps, but the line width will be the same along the whole line, even where the one-dot steps occur.

Advantageously, systems, apparatuses, and methods described herein may provide for technology that eliminates line width variability throughout a single swath, which improves the quality of any type of lines (e.g., lines with various numbers of pixels). Additionally, or alternatively, the techniques described herein may provide for technology that is a solution for both printers with only one printhead of each ink or several printheads of each ink. Further, the techniques described herein may provide for technology that robustly addresses odd/even misalignments, because a general line width may vary but will be maintained along the swath when utilizing the techniques described herein. Additionally, or alternatively, the techniques described herein may provide for technology that is performed without increasing a number of printing passes; therefore, a consistent throughput may be maintained.

Systems, apparatuses, and methods described in some implementations herein provide for technology that calibrates a printer alignment. For example, such calibrations may include determining a tilt value for individual columns. A difference may be determined between a first set of alignment values of nozzles of a first column of the trench and a second set of alignment values of nozzles of a second column of the trench. A dot offset value may be determined based on the difference between the first and second set of alignment values of nozzles of the first and second columns. A top nozzle alignment value of the second column may be adjusted based on a difference compared against the first set of alignment values of nozzles of the first column and based on the dot offset value, in some implementations.

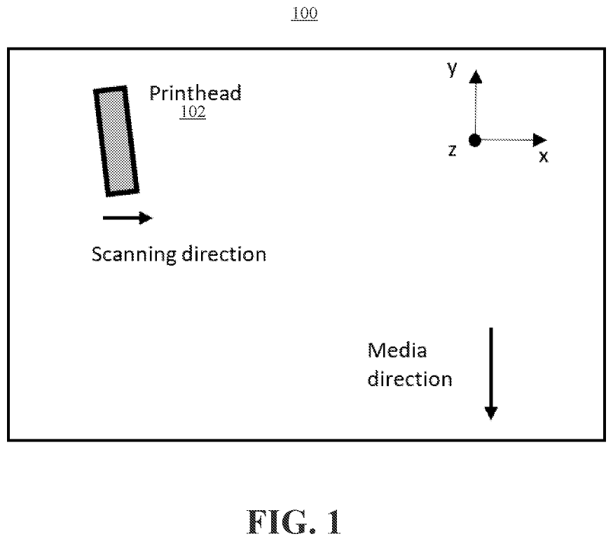

FIG. 1 is a schematic view illustrating a printer 100 including a printhead 102 deviated in the z-axis, e.g., being affected by a theta-Z deviation. As illustrated, when using single pass print-modes, a printing pen of a printhead 102 typically will go through each part of the plot surface only once and hence, the whole printhead 102 is going to be used to paint a line. In these cases, a fundamental problem is that occasionally there is not perfect vertical alignment with the media during printing operations. For example, in some cases a printhead pocket associated with the printhead 102 may be rotated and/or the printhead pocket may have some mechanical tolerance that may rotate, e.g., during installation. Additionally, or alternatively, a deviation may include a rotation with respect to an aligned position. For example, such an aligned position may be perpendicular to a print swath. This issue is defined as a theta-Z deviation of the printhead.

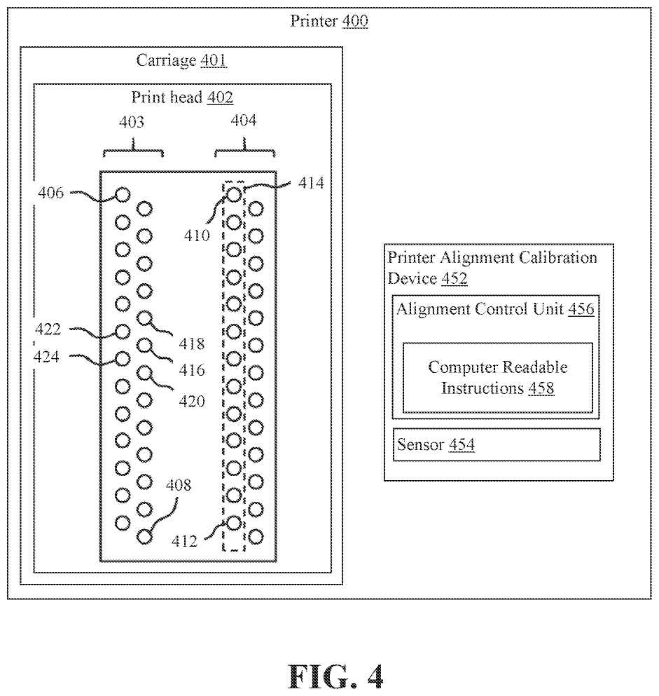

The moment in which a nozzle should be fired is typically defined in an alignment file of the printer. This alignment file is typically obtained by printing different types of patterns and analyzing them with a light sensor (e.g., sensor 454 of FIG. 4). When some theta-Z deviation is present, each nozzle of the printhead should in theory fire its ink drop at a different moment in time in order to print a perfect vertical line. However, this is not typically possible since a different alignment value is not provided to each nozzle of the printhead. Usually, the nozzles are distributed into a concrete number of nozzle groups and then the same alignment value is given to all the nozzles of that group. Additionally, the resolution of the alignment is another restriction. A minimum alignment differences that can be applied between the nozzles of the same printhead is limited by a minimum resolution. For example, a minimum alignment differences of one dot can be applied between the nozzles of the same printhead where the minimum resolution is one dot. Such a dot typically corresponds to 42 μm when printing at 600 dpi or 21 μm when printing at 1200 dpi.

In a printhead which suffer from a theta-Z deviation, the deviation may be compensated by giving different alignment values between the nozzles at the top of the printhead and the bottom. However, due to resolution limitations, these differences of alignment are converted to one dot steps when printing. Therefore, there is necessarily a concrete section of the printhead where there is a one dot difference between the upper and lower nozzles. These create steps in printed lines, which are especially noticeable when printing at 600 dpi because the step length is 42 μm.

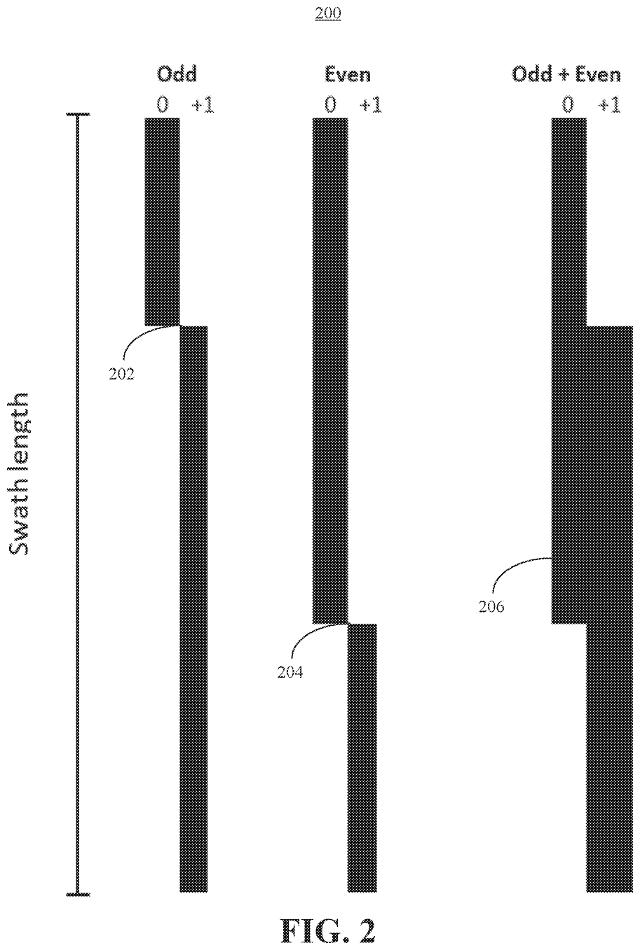

FIG. 2 is a chart 200 illustrating line width variation due to a theta-Z deviation. As illustrated, for printheads that contain two separated columns (e.g., named odd and even columns) within the same trench, this theta-Z deviation affects both trenches but the tilt for each column may not be exactly the same. For this reason, each trench may be aligned separately, where the theta-Z deviation is not always the same for each column and the one-dot steps may happen at different sections of the printhead (e.g., an odd one-dot step 202 and an even one-dot step 204). This causes width differences 206 along the same line which is printed by both columns (e.g., odd and even columns).

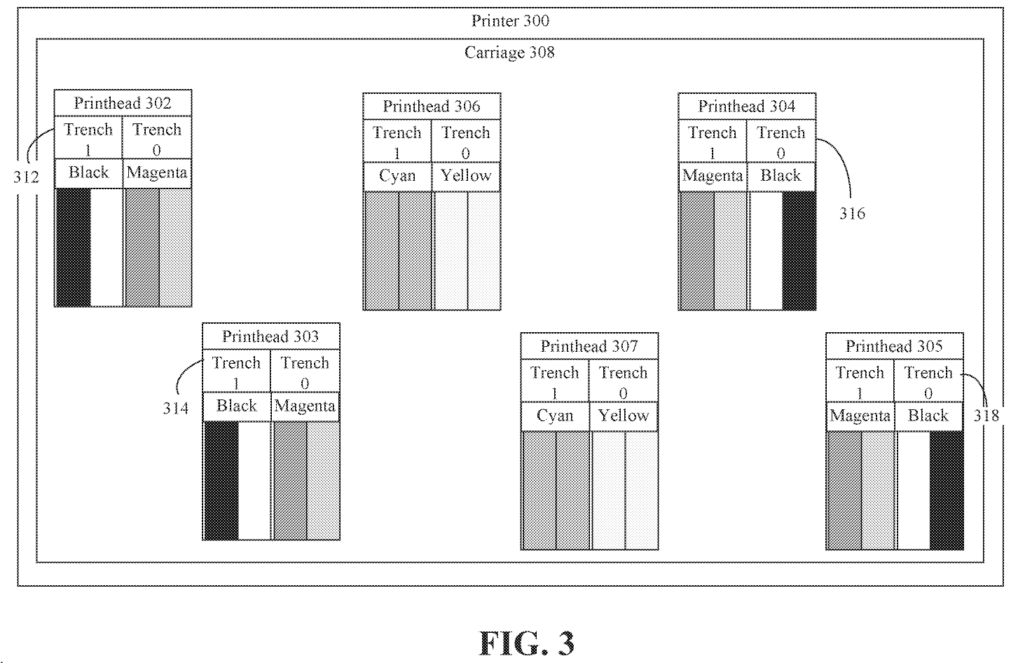

FIG. 3 is an illustration of an example printer 300 according to an example. As illustrated, in some printers, black lines are printed using printheads 302/303/304/305 placed at the edges of the carriage 308. In single pass print-modes for such printers, such a printer may have nozzles from trenches 312/314/316/318 of these printheads 302/303/304/305 take part in printing the lines. In such an example, black lines are printed with a printhead of each side of the carriage. For example, black lines are printed with two printheads in the left side and two printheads in the right side, where the printheads are staggered.

For example, some printers contain two separated black pens (e.g., a symmetric configuration), which are allocated at the edges of the carriage. In this case, variations caused by a theta-Z deviation are even more significative because four different trenches will be painting during the same swath scan. Therefore, more theta-Z steps would appear in the same line causing a continuous change in line width. A diagram of the carriage is attached below for clarity.

The nature of the defect in a symmetric configuration (e.g., in projects that have two separated black pens allocated at the edges of the carriage) is enhanced due to there being two printheads with a black channel on opposite sides of the carriage. Although this helps in many aspects, it creates the consequence of printing lines with those two printheads which are far apart and can have high relative dot placement errors and more one-dot steps related to theta-Z deviations.

As will be discussed in greater detail below, some implementations described herein ensure that both odd and even one-dot steps happen at the same position of the printhead. This will generate lines that still have one-dot steps, but the line width will be the same along the whole line, even where the one-dot steps occur.

Additional and/or alternative operations for printer 300 are described in greater detail below in the description of printer 400 of FIG. 4.

FIG. 4 is an illustration of an example simplification of a layout of a printer 400 having nozzles on a print head 402 according to an example. As illustrated, the printer 400 includes a carriage 401, which includes a plurality of printheads 402.

In the illustrated example, the print head 402 includes a first set of nozzles, generally indicated as trench 403, and a second set of nozzles, generally indicated as trench 404. In other examples, the print head 402 may include any number of one or more sets of nozzles. Each set of nozzles may be associated with one color of print agent. For example, the first set of nozzles 403 may dispense a first color of print agent, such as black, and the second set of nozzles 404 may dispense a second color of print agent, such as cyan.

In some examples, the physical location of nozzles on the print head may determine the physical position of a dispensed print agent drop. For example, in the first set of nozzles of trench 403, a nozzle 406 located at one end of the set of nozzles of trench 403 may dispense a drop that results in a different signal from a nozzle 408 located at the other end. Furthermore, a drop dispensed from another set of nozzles, for example the nozzle 410 or 412 dispensed from the second set of nozzles of trench 404, may also result in a different signal. In some examples, the nozzles in a set of nozzles on a print head may be arranged in columns nozzles. FIG. 4 shows an example of a column of nozzles 414. For example, a column of nozzles, which corresponds to half a trench, may be called odd or even. Here the column of nozzles 414 is an odd column, which is directly adjacent an even column in the second set of nozzles of trench 404. In the first set of nozzles of trench 403, an example nozzle 416 may be adjacent to nozzles 418 and 420 in the same trench, and also adjacent to nozzles 422 and 424 in the set of nozzles (e.g., not in the same trench). In some examples, a print head may include one, two or more sets of nozzles, and/or the print head may include multiple arrangements of a print head 402 as shown in FIG. 4.

As illustrated, in some implementations, the printer 400 further includes a printer alignment calibration device 452 operatively associated with each column of each trench of print head 402. In some examples, the printer alignment calibration device 452 includes a sensor 454 and an alignment control unit 456 (e.g., and alignment controller) coupled to the sensor 454. In some implementations, the alignment control unit 456 is adapted for printing in a single pass print-mode. Alternatively, the alignment control unit 456 may be adapted for printing in a multi-pass print-mode.

In some examples, the moment in which a nozzle should be fired is typically defined in an alignment file of the printer. This alignment file is typically obtained by printing different types of patterns and analyzing them with a light sensor (e.g., sensor 454 of FIG. 4), the like, and/or combinations thereof.

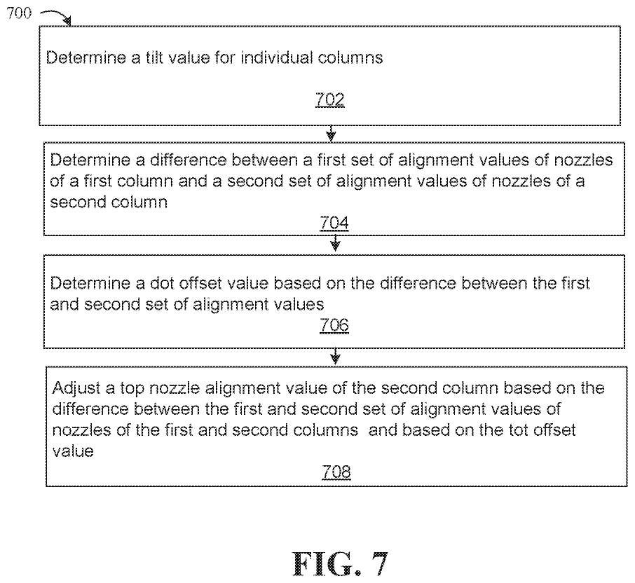

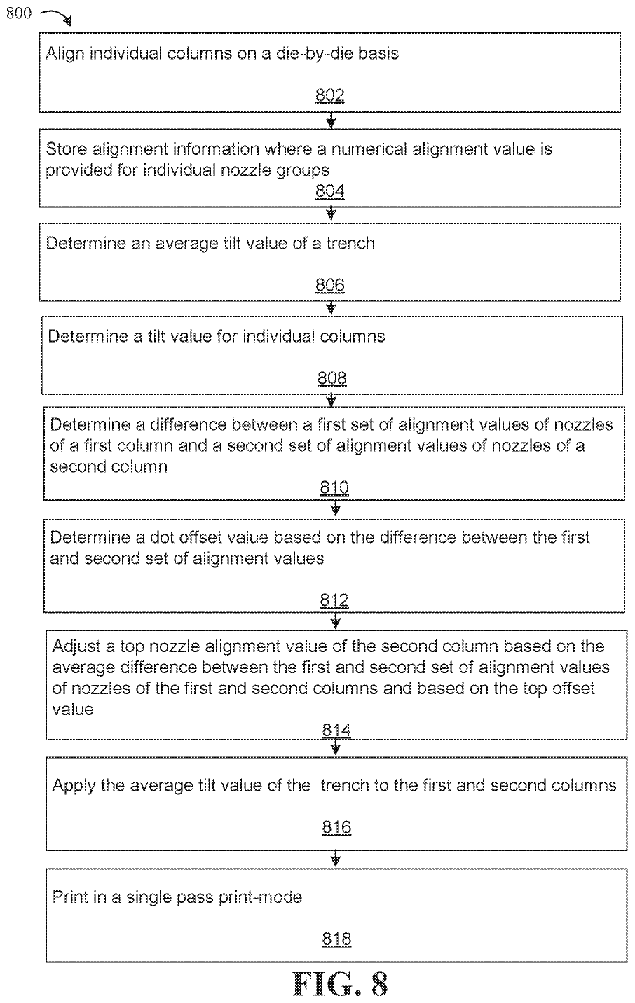

In some implementations, the alignment control unit 456 may include computer readable instructions 458 (e.g., software, firmware, hardware, the like, and/or combinations thereof), which may be associated with each column of each trench of print head 402. Additionally, or alternatively, all or portions of the computer readable instructions 458 of the alignment control unit 456 may be associated with another computing device (e.g., a mobile device). The operations of the computer readable instructions 458 of the alignment control unit 456 are described in greater detail below in FIG. 7 and/or FIG. 8.

In operation, as discussed above, some implementations described herein ensure that both odd and even one-dot steps happen at the same position of the printhead. This will generate lines that still have one-dot steps, but the line width will be the same along the whole line, even where the one-dot steps occur. More specifically, some implementations described herein ensure that both odd and even one-dot steps happen at the same position of the printhead. This will generate lines with one-dot steps, but the line width will be the same along the whole line.

It should be stated that this procedure assumes that theta-Z deviation of both columns within a trench would be in the same direction. It is a sound assumption, since both trenches are parallel within the printhead and therefore, the tilt would be in the same direction.

In order to apply this procedure, first of all both columns will be aligned separately. Then, an average difference in dots at a particular printing resolution between the whole odd and the even nozzles will be calculated. This difference is maintained sufficiently constant throughout all the printhead length.

In some examples, if the alignment difference between odd and even columns is lower than ±0.5 dots, the alignment values of one of the columns is copied to the other one. The modification of these values will typically not cause any dot placement error since the difference that has been applied is lower than the printing resolution. However, this will cause the one-dot steps due to theta-Z compensation to happen in the same nozzle group in both columns.

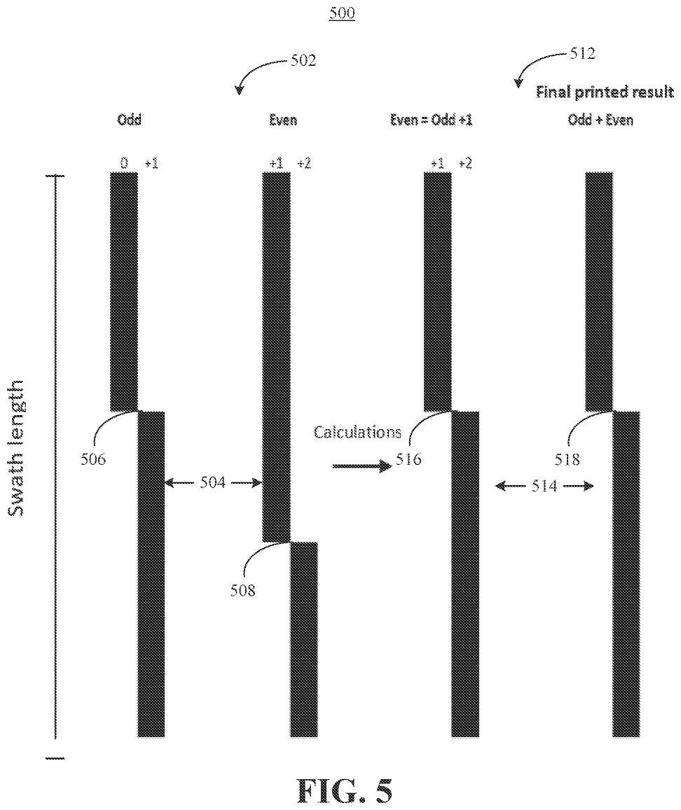

Additionally, or alternatively, in some implementations, if the alignment difference between odd and even columns are between ±0.5 dots and ±1.5 dots, the alignment values of one of the columns ±1 dot (depending on the tilt direction) is copied to the other one. By doing this, the odd versus even alignment would be takin into account whereas the one-dot steps due to theta-Z compensation will happen in the same nozzle group with its corresponding offset of a multiple of one dot. This is schematized in FIG. 5, which is described in greater detail below.

The description above corresponds to a carriage with only one black printhead with odd and even columns. A similar procedure can be done in a printer with two black printheads, in some implementations. However, in such a case, instead of only calculate the average between the odd and even columns of one printhead, the average of the two odd columns of the two different printheads is first calculated and then copied one to the other with the one-dot multiplicity, for example. Afterwards, a procedure similar to the one explained above is repeated for each even column with its corresponding odd column. By doing this, the one-dot steps due to theta-Z compensation will happen in the same nozzle group for each one of the four columns (e.g., with a multiple to one dot corresponding offset).

FIG. 5 is a chart 500 illustrating an adjusted trench alignment to address line width variation due to a theta-Z deviation according to an example. As illustrated, the difference between a two-pixel line printed at 600 dpi before and after application of the procedures described herein.

As illustrated, it can be seen how an existing line 502, in which the procedures described herein have not been applied, shows a change in line width 512 in the position where the odd one-step theta-Z correction 506 is applied at a different point as compared to the position where the even one-step theta-Z correction 508 is applied. Conversely, in a corrected line 512, in which the procedures described herein were applied, there is a clear one-pixel step but there is no width variation 514 through the line in the position where the odd one-step theta-Z correction 516 is applied at the same point as compared to the position where the even one-step theta-Z correction 518 is applied. The illustrated case corresponds to a printer with only one black printhead (e.g., non-symmetric configuration).

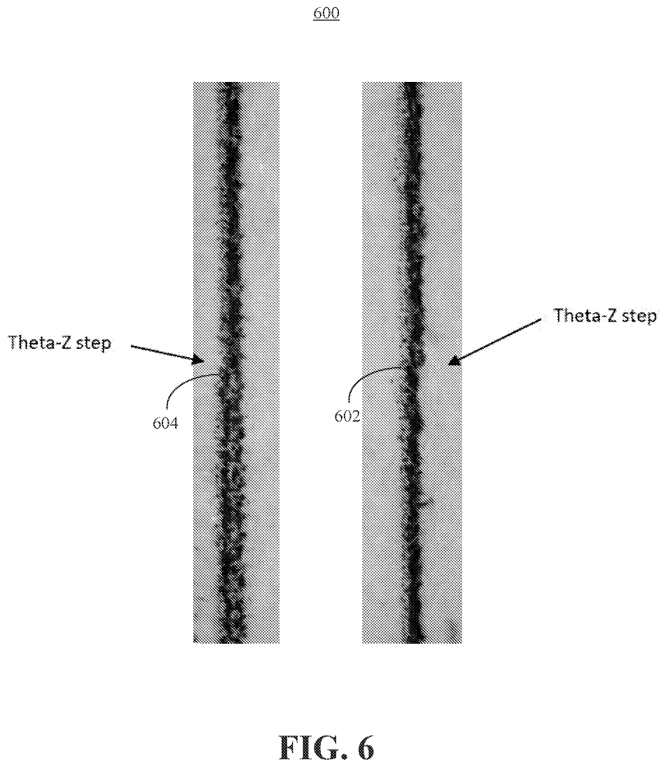

FIG. 6 is an image chart 600 illustrating experimental results of an adjusted trench alignment to address line width variation due to a theta-Z deviation according to an example. As illustrated, in some implementations, the procedures described herein can be detected in alignment patterns. For example, a plot that is printed during an alignment process will typically show that the odd and even columns are aligned separately, and therefore its theta-Z should be different. However, when printing a line plot 602 when the procedures described herein were applied, it can typically be seen that theta-Z steps produce a one-dot step in both columns at the same time. Conversely, an existing printed line plot 604, in which the procedures described herein have not been applied, typical shows a change in width that would be seen if each odd and even column is aligned separately.

FIG. 7 is an illustration of a flowchart of an example method 700 for column alignment to address line width variation due to a theta-Z deviation according to an example. As illustrated, the method 700 may generally be implemented in a printing system, such as, for example, the printer 400 (FIG. 4), already discussed.

In an example, the method 700 may be implemented in computer readable instructions (e.g., software), configurable computer readable instructions (e.g., firmware), fixed-functionality computer readable instructions (e.g., hardware), etc., or any combination thereof.

Illustrated processing block 702 provides for determining a tilt value for individual columns. For example, a tilt value for individual columns of a trench associated with a print head may be determined, where the tilt value is based on a difference between a top nozzle alignment value and a bottom nozzle alignment value for individual columns of the trench.

Illustrated processing block 704 provides for determining a difference between a first set of alignment values of nozzles of a first column of the trench and a second set of alignment values of nozzles of a second column of the trench. For example, an average difference may be determined between a first set of alignment values of nozzles of a first column of the trench and a second set of alignment values of nozzles of a second column of the trench.

Illustrated processing block 706 provides for determining a dot offset value. For example, a dot offset value may be determined based on the difference between the first and second set of alignment values of nozzles of the first and second columns. In some implementations, such a dot offset value may be determined based on the average difference between the first and second set of alignment values of nozzles of the first and second columns.

Illustrated processing block 708 provides for adjusting a top nozzle alignment value of the second column. For example, a top nozzle alignment value of the second column may be adjusted based on the difference between the first and second set of alignment values of nozzles of the first and second columns and based on the dot offset value. In some implementations, the top nozzle alignment value of the second column may be adjusted based on the average difference between the first and second set of alignment values of nozzles of the first and second columns and based on the dot offset value.

It will be appreciated that some or all of the operations in method 700 are described using a “pull” architecture (e.g., polling for new information followed by a corresponding response) may instead be implemented using a “push” architecture (e.g., sending such information when there is new information to report), and vice versa.

Additional and/or alternative operations for method 700 are described in greater detail below in the description of FIG. 8.

FIG. 8 is an illustration of a flowchart of another example method 800 for column alignment to address line width variation due to a theta-Z deviation according to an example. As illustrated, the method 800 may generally be implemented in a printing system, such as, for example, the printer 400 (FIG. 4), already discussed.

In an example, the method 800 may be implemented in computer readable instructions (e.g., software), configurable computer readable instructions (e.g., firmware), fixed-functionality computer readable instructions (e.g., hardware), etc., or any combination thereof.

Illustrated processing block 802 provides for aligning individual columns of two or more trenches of two or more print heads on a die-by-die basis. For example, individual columns may be aligned prior to determining a tilt value, as will be described in greater detail below. In some implementations, in a carriage (e.g., like the carriage described in FIGS. 3-4) a printhead typically contains one die per printhead, where the die contain two trenches and each trench has two columns. However, in other implementations, a single printhead can contain several dies. In this case, each trench within each die would be aligned separately utilizing the procedures described herein.

Illustrated processing block 804 provides for storing alignment information where a numerical alignment value is provided for individual nozzle groups. For example, the tilt value may be determined based on the numerical alignment value, as will be described in greater detail below.

Illustrated processing block 806 provides for determining an average tilt value of a trench. For example, an average tilt value of a trench may be determined prior to adjusting a top nozzle alignment value of a second column, as will be described in greater detail below.

Illustrated processing block 808 provides for determining a tilt value for individual columns. For example, a tilt value for individual columns of a trench associated with a print head may be determined, where the tilt value is based on a difference between a top nozzle alignment value and a bottom nozzle alignment value for individual columns of the trench.

Illustrated processing block 810 provides for determining a difference between a first set of alignment values of nozzles of a first column of the trench and a second set of alignment values of nozzles of a second column of the trench. For example, an average difference may be determined between a first set of alignment values of nozzles of a first column of the trench and a second set of alignment values of nozzles of a second column of the trench.

Illustrated processing block 812 provides for determining a dot offset value. For example, a dot offset value may be determined based on the difference between the first and second set of alignment values of nozzles of the first and second columns. In some implementations, such a dot offset value may be determined based on the average difference between the first and second set of alignment values of nozzles of the first and second columns.

Illustrated processing block 814 provides for adjusting a top nozzle alignment value of the second column. For example, a top nozzle alignment value of the second column may be adjusted based on the difference between the first and second set of alignment values of nozzles of the first and second columns and based on the dot offset value. In some implementations, the top nozzle alignment value of the second column may be adjusted based on the average difference between the first and second set of alignment values of nozzles of the first and second columns and based on the dot offset value.

Additionally, or alternatively, adjusting the top nozzle alignment value of the second column may further include copying the top nozzle alignment value of the first column to the top nozzle alignment value of the second column with: a zero dot offset value when the average difference between the first and second set of alignment values of nozzles of the first and second columns is in a first range; a one dot offset value when the average difference between the first and second set of alignment values of nozzles of the first and second columns is in a second range, and a two dot offset value when the average difference between the first and second set of alignment values of nozzles of the first and second columns is in a third range.

In implementations where a carriage has only a single die per ink type (e.g., where the first column is an odd column and the second column is an even column) processing block 814 may provide for copying the top nozzle alignment value of the first column to the top nozzle alignment value of the second column with a zero dot offset value when average difference between the first and second set of alignment values of nozzles of the first and second columns is lower than plus or minus 0.5 dots, one dot offset value when the average difference between the first and second set of alignment values of nozzles of the first and second columns is between plus or minus 0.5 dots and plus or minus 1.5 dots, a two dot offset value when the average difference between the first and second set of alignment values of nozzles of the first and second columns is between plus or minus 1.5 dots and plus or minus 2.5 dots, and a three dot offset value when the average difference between the first and second set of alignment values of nozzles of the first and second columns is between plus or minus 2.5 dots and plus or minus 3.5 dots.

In implementations where a carriage has two dies per ink type (e.g., where the first column is a first odd column and the second column is a second odd column that are positioned within a same printhead row) processing block 814 may provide for copying the top nozzle alignment value of the first column to the top nozzle alignment value of the second column with a zero dot offset value when the average difference between the first and second set of alignment values of nozzles of the first and second columns is lower than plus or minus 0.5 dots, one dot offset value when the average difference between the first and second set of alignment values of nozzles of the first and second columns is between plus or minus 0.5 dots and plus or minus 1.5 dots, a two dot offset value when the average difference between the first and second set of alignment values of nozzles of the first and second columns is between plus or minus 1.5 dots and plus or minus 2.5 dots, and a three dot offset value when the average difference between the first and second set of alignment values of nozzles of the first and second columns difference between the top nozzle alignment values of the first and second columns is between plus or minus 2.5 dots and plus or minus 3.5 dots.

Illustrated processing block 816 provides for applying the average tilt value of the trench to the first and second columns. For example, the average tilt value of the trench to the first and second columns may be applied after adjusting the top nozzle alignment value of the second column.

Illustrated processing block 818 provides for printing in a single pass print-mode, although other numbers of print passes may be utilized in some implementations.

Additionally, or alternatively, in implementations where a carriage has two dies per ink type (e.g., where the first column is a first odd column and the second column is a second odd column that are positioned within a same printhead row) method 800 may provide for determining a difference between the top nozzle alignment value of an odd column of the trench and the top nozzle alignment value of an immediately adjacent even column of the trench. In such an implementation, method 800 may further provide for determining, prior to determining the average difference between the first and second set of alignment values of nozzles of the first and second columns, an average theta-z value based on a theta-Z value of the odd column and a theta-Z value of the even column. Method 800 may further provide for determining an even column dot offset value based on an average difference between the top nozzle alignment values of the odd and even columns. Method 800 may further provide for adjusting the top nozzle alignment value of the even column based on an average of the first set of alignment values of nozzles of the odd column and based on the even column dot offset value. Method 800 may further provide for adjusting remaining nozzle alignment values of each column based on the average theta-z value.

It will be appreciated that some or all of the operations in method 800 are described using a “pull” architecture (e.g., polling for new information followed by a corresponding response) may instead be implemented using a “push” architecture (e.g., sending such information when there is new information to report), and vice versa.

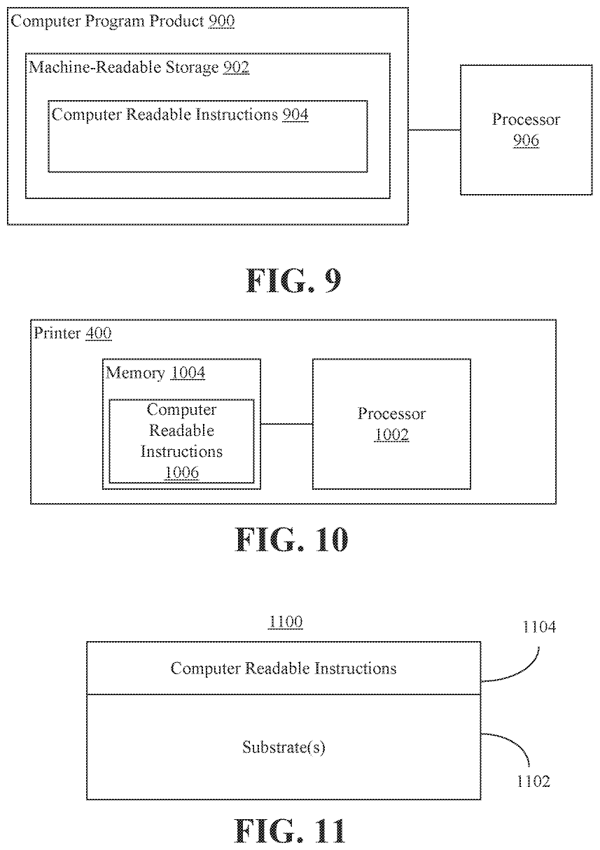

FIG. 9 illustrates a block diagram of an example computer program product 900. In some examples, as shown in FIG. 9, computer program product 900 includes a machine-readable storage 902 that may also include computer readable instructions 904. In some implementations, the machine-readable storage 902 may be implemented as a non-transitory machine-readable storage. In some implementations the computer readable instructions 904, which may be implemented as software, for example. In an example, the computer readable instructions 904, when executed by a processor 906, implement one or more aspects of the method 700 (FIG. 7), the method 800 (FIG. 8), and/or the printer 400 (FIG. 4), already discussed, already discussed.

FIG. 10 shows an illustrative example of the printer 400. In the illustrated example, the printer 400 may include a processor 1002 and a memory 1004 communicatively coupled to the processor 1002. The memory 1004 may include computer readable instructions 1006, which may be implemented as software, for example. In an example, the computer readable instructions 1006, when executed by the processor 1002, implement one or more aspects of the method 700 (FIG. 7), the method 800 (FIG. 8), and/or the printer 400 (FIG. 4), already discussed.

In some implementations, the processor 1002 may include a general purpose controller, a special purpose controller, a storage controller, a storage manager, a memory controller, a micro-controller, a general purpose processor, a special purpose processor, a central processor unit (CPU), the like, and/or combinations thereof.

Further, implementations may include distributed processing, component/object distributed processing, parallel processing, the like, and/or combinations thereof. For example, virtual computer system processing may implement one or more of the methods or functionalities as described herein, and the processor 1002 described herein may be used to support such virtual processing.

In some examples, the memory 1004 is an example of a computer-readable storage medium. For example, memory 1004 may be any memory which is accessible to the processor 1002, including, but not limited to RAM memory, registers, and register files, the like, and/or combinations thereof. References to “computer memory” or “memory” should be interpreted as possibly being multiple memories. The memory may for instance be multiple memories within the same computer system. The memory may also be multiple memories distributed amongst multiple computer systems or computing devices.

FIG. 11 shows an illustrative semiconductor apparatus 1100 (e.g., chip and/or package). The illustrated apparatus 1100 includes one or more substrates 1102 (e.g., silicon, sapphire, or gallium arsenide) and computer readable instructions 1104 (such as, configurable computer readable instructions (e.g., firmware) and/or fixed-functionality computer readable instructions (e.g., hardware)) coupled to the substrate(s) 1102. In an example, the computer readable instructions 1104 implement one or more aspects of the method 700 (FIG. 7), the method 800 (FIG. 8), and/or the printer 400 (FIG. 4), already discussed.

In some implementations, computer readable instructions 1104 may include transistor array and/or other integrated circuit/IC components. For example, configurable firmware logic and/or fixed-functionality hardware logic implementations of the computer readable instructions 1104 may include configurable computer readable instructions such as, for example, programmable logic arrays (PLAs), field programmable gate arrays (FPGAs), complex programmable logic devices (CPLDs), or fixed-functionality computer readable instructions (e.g., hardware) using circuit technology such as, for example, application specific integrated circuit (ASIC), complementary metal oxide semiconductor (CMOS) or transistor-transistor logic (TTL) technology, the like, and/or combinations thereof.

As discussed above, some implementations described herein advantageously provide for technology that eliminates line width variability throughout a single swath, which improves the quality of any type of lines (e.g., lines with various numbers of pixels). Additionally, or alternatively, the techniques described herein may provide for technology that is a solution for both printers with only one printhead of each ink or several printheads of each ink. Further, the techniques described herein may provide for technology that robustly addresses odd/even misalignments, because a general line width may vary but will be maintained along the swath when utilizing the techniques described herein. Additionally, or alternatively, the techniques described herein may provide for technology that is performed without increasing a number of printing passes; therefore, a consistent throughput may be maintained.

All definitions, as defined and used herein, should be understood to control over dictionary definitions, definitions in documents incorporated by reference, and/or ordinary meanings of the defined terms.

Furthermore, for ease of understanding, certain functional blocks may have been delineated as separate blocks; however, these separately delineated blocks should not necessarily be construed as being in the order in which they are discussed or otherwise presented herein. For example, some blocks may be able to be performed in an alternative ordering, simultaneously, etc.

Although a number of illustrative examples are described herein, it should be understood that numerous other modifications and examples can be devised by those skilled in the art that will fall within the spirit and scope of the principles of the foregoing disclosure. More particularly, reasonable variations and modifications are possible in the component parts and/or arrangements of the subject combination arrangement within the scope of the foregoing disclosure, the drawings and the appended claims without departing from the spirit of the foregoing disclosure. In addition to variations and modifications in the component parts and/or arrangements, alternative uses will also be apparent to those skilled in the art. The examples may be combined to form additional examples.

We claim:

1. A printer alignment calibration method, for a printer, comprising:
determining a tilt value for individual columns of a trench associated with a print head, wherein the tilt value is based on a difference between a top nozzle alignment value and a bottom nozzle alignment value for individual columns of the trench;
determining an average difference between a first set of alignment values of nozzles of a first column of the trench and a second set of alignment values of nozzles of a second column of the trench;
determining a dot offset value based on the average difference between the first and second set of alignment values of nozzles of the first and second columns;
adjusting the top nozzle alignment value of the second column based on the average difference between the first and second set of alignment values of nozzles of the first and second columns and based on the dot offset value.

2. The printer alignment calibration method of claim 1, further comprising:
determining an average tilt value of the trench prior to adjusting the top nozzle alignment value of the second column; and
applying the average tilt value to the first and second columns after adjusting the top nozzle alignment value of the second column.

3. The printer alignment calibration method of claim 1, wherein adjusting the top nozzle alignment value of the second column further comprises:
copying the top nozzle alignment value of the first column to the top nozzle alignment value of the second column with: a zero dot offset value when the average difference between the first and second set of alignment values of nozzles of the first and second columns is in a first range, a one dot offset value when the average difference between the first and second set of alignment values of nozzles of the first and second columns is in a second range, and a two dot offset value when the average difference between the first and second set of alignment values of nozzles of the first and second columns is in a third range.

4. The printer alignment calibration method of claim 1, further comprising, for a carriage with only a single die per ink type:
wherein the first column is an odd column and the second column is an even column,
copying the top nozzle alignment value of the first column to the top nozzle alignment value of the second column with: a zero dot offset value when average difference between the first and second set of alignment values of nozzles of the first and second columns is lower than plus or minus 0.5 dots, a one dot offset value when the average difference between the first and second set of alignment values of nozzles of the first and second columns is between plus or minus 0.5 dots and plus or minus 1.5 dots, a two dot offset value when the average difference between the first and second set of alignment values of nozzles of the first and second columns is between plus or minus 1.5 dots and plus or minus 2.5 dots, and a three dot offset value when the average difference between the first and second set of alignment values of nozzles of the first and second columns is between plus or minus 2.5 dots and plus or minus 3.5 dots.

5. The printer alignment calibration method of claim 1, further comprising, for a carriage with two dies per ink type:
wherein the first column is a first odd column and the second column is a second odd column that are positioned within a same printhead row,
copying the top nozzle alignment value of the first column to the top nozzle alignment value of the second column with: a zero dot offset value when the average difference between the first and second set of alignment values of nozzles of the first and second columns is lower than plus or minus 0.5 dots, a one dot offset value when the average difference between the first and second set of alignment values of nozzles of the first and second columns is between plus or minus 0.5 dots and plus or minus 1.5 dots, a two dot offset value when the average difference between the first and second set of alignment values of nozzles of the first and second columns is between plus or minus 1.5 dots and plus or minus 2.5 dots, and a three dot offset value when the average difference between the first and second set of alignment values of nozzles of the first and second columns difference between the top nozzle alignment values of the first and second columns is between plus or minus 2.5 dots and plus or minus 3.5 dots;
determining a difference between the top nozzle alignment value of an odd column of the trench and the top nozzle alignment value of an immediately adjacent even column of the trench;
determining, prior to determining the average difference between the first and second set of alignment values of nozzles of the first and second columns, an average theta-z value based on a theta-Z value of the odd column and a theta-Z value of the even column;
determining an even column dot offset value based on an average difference between the top nozzle alignment values of the odd and even columns;
adjusting the top nozzle alignment value of the even column based on an average of the first set of alignment values of nozzles of the odd column and based on the even column dot offset value; and
adjusting remaining nozzle alignment values of each column based on the average theta-z value.

6. The printer alignment calibration method of claim 1, further comprising:
aligning individual columns of the two or more trenches of two or more print heads on a die-by-die basis, wherein the aligning occurs prior to determining the tilt value; and
storing alignment information where a numerical alignment value is provided for individual nozzle groups, wherein the tilt value is determined based on the numerical alignment value.

7. The printer alignment calibration method of claim 1, further comprising:
printing in a single pass print-mode.

8. A printer alignment calibration device, for a printer, comprising:
a sensor;
an alignment controller coupled to the sensor, the alignment controller to:
determine a tilt value for individual columns of a trench associated with a print head, wherein the tilt value is based on a difference between a top nozzle alignment value and a bottom nozzle alignment value for individual columns of the trench;
determine an average difference between a first set of alignment values of nozzles of a first column of the trench and a second set of alignment values of nozzles of a second column of the trench;
determine a dot offset value based on the average difference between the first and second set of alignment values of nozzles of the first and second columns;
adjust the top nozzle alignment value of the second column based on the average difference between the first and second set of alignment values of nozzles of the first and second columns and based on the dot offset value.

9. The printer alignment calibration device of claim 8, the alignment controller further to:
determine an average tilt value of the trench prior to adjusting the top nozzle alignment value of the second column; and
apply the average tilt value to the first and second columns after adjusting the top nozzle alignment value of the second column.

10. The printer alignment calibration device of claim 8, wherein adjusting the top nozzle alignment value of the second column further comprises the alignment controller further to:
copy the top nozzle alignment value of the first column to the top nozzle alignment value of the second column with: a zero dot offset value when the average difference between the first and second set of alignment values of nozzles of the first and second columns is in a first range, a one dot offset value when the average difference between the first and second set of alignment values of nozzles of the first and second columns is in a second range, and a two dot offset value when the average difference between the first and second set of alignment values of nozzles of the first and second columns is in a third range.

11. The printer alignment calibration device of claim 8, further comprising, for a carriage with only a single die per ink type, the alignment controller further to:
wherein the first column is an odd column and the second column is an even column,
copy the top nozzle alignment value of the first column to the top nozzle alignment value of the second column with: a zero dot offset value when average difference between the first and second set of alignment values of nozzles of the first and second columns is lower than plus or minus 0.5 dots, a one dot offset value when the average difference between the first and second set of alignment values of nozzles of the first and second columns is between plus or minus 0.5 dots and plus or minus 1.5 dots, a two dot offset value when the average difference between the first and second set of alignment values of nozzles of the first and second columns is between plus or minus 1.5 dots and plus or minus 2.5 dots, and a three dot offset value when the average difference between the first and second set of alignment values of nozzles of the first and second columns is between plus or minus 2.5 dots and plus or minus 3.5 dots.

12. The printer alignment calibration device of claim 8, further comprising, for a carriage with two dies per ink type, the alignment controller further to:
wherein the first column is a first odd column and the second column is a second odd column that are positioned within a same printhead row,
copy the top nozzle alignment value of the first column to the top nozzle alignment value of the second column with: a zero dot offset value when the average difference between the first and second set of alignment values of nozzles of the first and second columns is lower than plus or minus 0.5 dots, a one dot offset value when the average difference between the first and second set of alignment values of nozzles of the first and second columns is between plus or minus 0.5 dots and plus or minus 1.5 dots, a two dot offset value when the average difference between the first and second set of alignment values of nozzles of the first and second columns is between plus or minus 1.5 dots and plus or minus 2.5 dots, and a three dot offset value when the average difference between the first and second set of alignment values of nozzles of the first and second columns difference between the top nozzle alignment values of the first and second columns is between plus or minus 2.5 dots and plus or minus 3.5 dots;
determine a difference between the top nozzle alignment value of an odd column of the trench and the top nozzle alignment value of an immediately adjacent even column of the trench;
determine, prior to determining the average difference between the first and second set of alignment values of nozzles of the first and second columns, an average theta-z value based on a theta-Z value of the odd column and a theta-Z value of the even column;
determine an even column dot offset value based on an average difference between the top nozzle alignment values of the odd and even columns;
adjust the top nozzle alignment value of the even column based on an average of the first set of alignment values of nozzles of the odd column and based on the even column dot offset value; and
adjust remaining nozzle alignment values of each column based on the average theta-z value.

13. The printer alignment calibration device of claim 8, the alignment controller further to:
align individual columns of the two or more trenches of two or more print heads on a die-by-die basis, wherein the aligning occurs prior to determining the tilt value; and
store alignment information where a numerical alignment value is provided for individual nozzle groups, wherein the tilt value is determined based on the numerical alignment value.

14. A printer, comprising:
a print head; and
a printer alignment calibration device coupled to the print head, the printer alignment calibration device comprising:
a sensor;
an alignment controller coupled to the sensor, the alignment controller to:
determine a tilt value for individual columns of a trench associated with a print head, wherein the tilt value is based on a difference between a top nozzle alignment value and a bottom nozzle alignment value for individual columns of the trench;
determine a difference between a first set of alignment values of nozzles of a first column of the trench and a second set of alignment values of nozzles of a second column of the trench;
determine a dot offset value based on the difference between the first and second set of alignment values of nozzles of the first and second columns;
adjust the top nozzle alignment value of the second column based on the difference between the first and second set of alignment values of nozzles of the first and second columns and based on the dot offset value.

15. The printer of claim 14, wherein the difference between the first set of alignment values of nozzles of the first column and the second set of alignment values of nozzles of the second column is an average difference, and
wherein the difference compared against the first set of alignment values of nozzles of the first column is an average difference.

16. The printer of claim 14, the alignment controller further to:
determine an average tilt value of the trench prior to adjusting the top nozzle alignment value of the second column; and
apply the average tilt value to the first and second columns after adjusting the top nozzle alignment value of the second column.

17. The printer of claim 15, wherein adjusting the top nozzle alignment value of the second column further comprises the alignment controller further to:
copy the top nozzle alignment value of the first column to the top nozzle alignment value of the second column with: a zero dot offset value when the average difference between the first and second set of alignment values of nozzles of the first and second columns is in a first range, a one dot offset value when the average difference between the first and second set of alignment values of nozzles of the first and second columns is in a second range, and a two dot offset value when the average difference between the first and second set of alignment values of nozzles of the first and second columns is in a third range.

18. The printer of claim 15, further comprising, for a carriage with only a single die per ink type, the alignment controller further to:
wherein the first column is an odd column and the second column is an even column,
copy the top nozzle alignment value of the first column to the top nozzle alignment value of the second column with: a zero dot offset value when average difference between the first and second set of alignment values of nozzles of the first and second columns is lower than plus or minus 0.5 dots, a one dot offset value when the average difference between the first and second set of alignment values of nozzles of the first and second columns is between plus or minus 0.5 dots and plus or minus 1.5 dots, a two dot offset value when the average difference between the first and second set of alignment values of nozzles of the first and second columns is between plus or minus 1.5 dots and plus or minus 2.5 dots, and a three dot offset value when the average difference between the first and second set of alignment values of nozzles of the first and second columns is between plus or minus 2.5 dots and plus or minus 3.5 dots.

19. The printer of claim 15, further comprising, for a carriage with two dies per ink type, the alignment controller further to:
wherein the first column is a first odd column and the second column is a second odd column that are positioned within a same printhead row,
copy the top nozzle alignment value of the first column to the top nozzle alignment value of the second column with: a zero dot offset value when the average difference between the first and second set of alignment values of nozzles of the first and second columns is lower than plus or minus 0.5 dots, a one dot offset value when the average difference between the first and second set of alignment values of nozzles of the first and second columns is between plus or minus 0.5 dots and plus or minus 1.5 dots, a two dot offset value when the average difference between the first and second set of alignment values of nozzles of the first and second columns is between plus or minus 1.5 dots and plus or minus 2.5 dots, and a three dot offset value when the average difference between the first and second set of alignment values of nozzles of the first and second columns difference between the top nozzle alignment values of the first and second columns is between plus or minus 2.5 dots and plus or minus 3.5 dots;
determine a difference between the top nozzle alignment value of an odd column of the trench and the top nozzle alignment value of an immediately adjacent even column of the trench;
determine, prior to determining the average difference between the first and second set of alignment values of nozzles of the first and second columns, an average theta-z value based on a theta-Z value of the odd column and a theta-Z value of the even column;
determine an even column dot offset value based on an average difference between the top nozzle alignment values of the odd and even columns;
adjust the top nozzle alignment value of the even column based on an average of the first set of alignment values of nozzles of the odd column and based on the even column dot offset value; and
adjust remaining nozzle alignment values of each column based on the average theta-z value.

20. The printer of claim 14, the alignment controller further to:
align individual columns of the two or more trenches of two or more print heads on a die-by-die basis, wherein the aligning occurs prior to determining the tilt value; and
store alignment information where a numerical alignment value is provided for individual nozzle groups, wherein the tilt value is determined based on the numerical alignment value.
